(19) United States
(12) Patent Application Publication
(10) Pub. No.: US 2024/0340230 A1
(43) Pub. Date: Oct. 10, 2024

(54) FRAMEWORK FOR CENTRALIZED MONITORING THE HEALTH OF REMOTE PACKET DATA NODES OF ROAMING PEERING PARTNERS OVER PUBLIC CLOUD

(71) Applicant: DISH WIRELESS L.L.C., ENGLEWOOD, CO (US)

(72) Inventors: Kenneth William Weber, JR., Littleton, CO (US); Sruthi Nair, Aurora, CO (US); Mohammad Dawood Shahdad, Aurora, CO (US); Jaya Chandra Chikatmarla, Highlands Ranch, CO (US)

(21) Appl. No.: 18/132,899

(22) Filed: Apr. 10, 2023

(51) Int. Cl. H04L 43/10; H04L 61/45

(52) U.S. Cl. CPC H04L 43/10; H04L 61/45; H04L 2101/668

(57) ABSTRACT

A disclosed method may include (i) obtaining, by a home cellular network service provider from a roaming cellular network service provider, a list of identifiers indicating respective ranges of Internet Protocol addresses that are targets for remote packet data nodes of the roaming cellular network service provider, (ii) for each respective server, in a list of respective servers that the home cellular network service provider assigned to respective geographic hubs, pinging through an on-demand cloud computing platform each usable Internet Protocol address indicated by each respective identifier in the list of identifiers, and (iii) discovering, by the home cellular network service provider, in response to the pinging, which Internet Protocol addresses indicated a healthy remote packet data node of the roaming cellular network service provider.

### BRIEF SUMMARY

The present disclosure is generally directed to detecting packet data nodes, as discussed in more detail below. In one example, a method may include (i) obtaining, by a home cellular network service provider from a roaming cellular network service provider, a list of identifiers indicating respective ranges of Internet Protocol addresses that are targets for remote packet data nodes of the roaming cellular network service provider, (ii) for each respective server, in a list of respective servers that the home cellular network service provider assigned to respective geographic hubs, pinging through an on-demand cloud computing platform each usable Internet Protocol address indicated by each respective identifier in the list of identifiers, and (iii) discovering, by the home cellular network service provider, in response to the pinging, which Internet Protocol addresses indicated a healthy remote packet data node of the roaming cellular network service provider.

In some examples, the list of identifiers comprises a list of subnet definitions.

In some examples, each respective identifier in the list of identifiers indicates a first set of bits assigned to a host and a remaining second set of bits assigned to a network definition.

In some examples, a set of usable Internet Protocol addresses indicated by each respective identifier in the list of identifiers comprises a continuous range of Internet Protocol addresses.

In some examples, the continuous range of Internet Protocol addresses excludes a starting network Internet Protocol address and an ending broadcast Internet Protocol address as defined by each respective identifier in the list of identifiers.

In some examples, a size of the continuous range is (2\hat{ }(32−the number of bits in the remaining set of bits assigned to the network definition))−2.

In some examples, the method further includes sorting the list of identifiers by the remaining second set of bits assigned to the network definition.

In some examples, pinging through the on-demand cloud computing platform includes obtaining access to the on-demand cloud computing platform and registering at least one virtual machine in the on-demand cloud computing platform.

In some examples, pinging through the on-demand cloud computing platform includes installing a program for pinging each usable Internet Protocol address indicated by each respective identifier in the list of identifiers and executing the program through the at least one virtual machine.

In some examples, the method further includes performing a differential operation between the list of identifiers and a second list of identifiers obtained at a subsequent point in time to ascertain which Internet Protocol addresses have been inserted into the second list of identifiers.

In some examples, a system may include at least one physical processor and a non-transitory computer-readable medium encoding instructions that, when executed by the at least one physical processor, cause operations to be performed comprising: (i) obtaining, by a home cellular network service provider from a roaming cellular network service provider, a list of identifiers indicating respective ranges of Internet Protocol addresses that are targets for remote packet data nodes of the roaming cellular network service provider, (ii) for each respective server, in a list of respective servers that the home cellular network service provider assigned to respective geographic hubs, pinging through an on-demand cloud computing platform each usable Internet Protocol address indicated by each respective identifier in the list of identifiers, and (iii) discovering, by the home cellular network service provider, in response to the pinging, which Internet Protocol addresses indicated a healthy remote packet data node of the roaming cellular network service provider.

In some examples, a non-transitory computer-readable medium can encode instructions that, when executed by at least one physical processor of a computing device, cause the computing device to perform a method comprising: (i) obtaining, by a home cellular network service provider from a roaming cellular network service provider, a list of identifiers indicating respective ranges of Internet Protocol addresses that are targets for remote packet data nodes of the roaming cellular network service provider, (ii) for each respective server, in a list of respective servers that the home cellular network service provider assigned to respective geographic hubs, pinging through an on-demand cloud computing platform each usable Internet Protocol address indicated by each respective identifier in the list of identifiers, and (iii) discovering, by the home cellular network service provider, in response to the pinging, which Internet Protocol addresses indicated a healthy remote packet data node of the roaming cellular network service provider.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 shows a flow diagram for an example method for detecting packet data nodes.

FIG. 2 shows a diagram of a home cellular network service provider connecting to a roaming cellular network service provider through a serving gateway.

FIG. 3 shows two diagrams contrasting performance of a series of pinging operations through a custom-built server farm and through an on-demand cloud computing platform, respectively.

FIG. 4 shows a table of respective subnet definitions.

FIG. 5 shows a table indicating results of performing a differential operation between two lists of subnet definitions.

FIG. 6 shows a table of respective subnet definitions expanded to further show a network Internet Protocol address, a broadcast Internet Protocol address, and a continuous range of usable Internet Protocol addresses.

FIG. 7 shows a table indicating results of performing a series of pinging operations.

FIG. 8 shows a table listing Internet Protocol addresses where a functional serving gateway of a roaming cellular network service provider was successfully found.

FIG. 9 shows a portion of the table illustrating examples of Internet Protocol addresses where a functional serving gateway of a roaming cellular network service provider was successfully found.

FIG. 10 shows an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

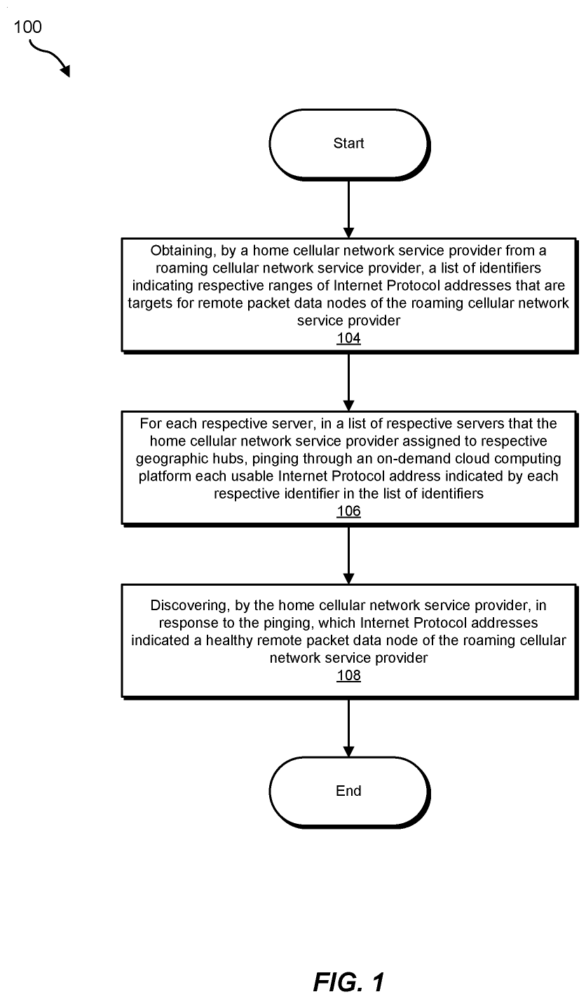

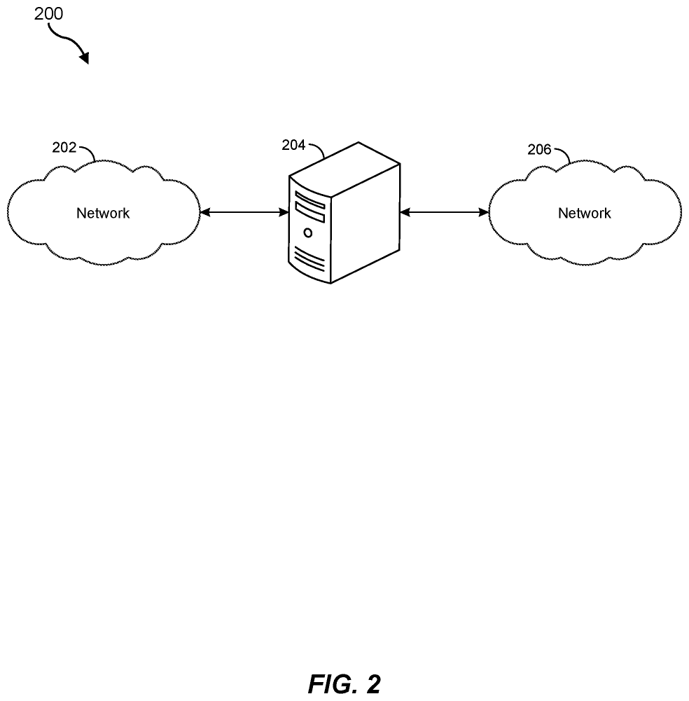

FIG. 1 shows a flow diagram for an example method 100 for detecting packet data nodes. At step 104, one or more of the systems described herein may obtain, as part of a home cellular network service provider from a roaming cellular network service provider, a list of identifiers indicating respective ranges of Internet Protocol addresses that are targets for remote packet data nodes of the roaming cellular network service provider. At step 106, one or more of the systems described herein may, for each respective server, in a list of respective servers that the home cellular network service provider assigned to respective geographic hubs, pinging through an on-demand cloud computing platform each usable Internet Protocol address indicated by each respective identifier in the list of identifiers. At step 108, one or more of the systems herein can, as part of the home cellular network service provider, and in response to the pinging, discover which Internet Protocol addresses indicated a healthy remote packet data node of the roaming cellular network service provider. As used herein, the term “target” can generally refer to an address or a range of addresses where a remote packet data node is indicated as potentially being located. Additional details and/or further descriptions of various embodiments of method 100 will be described below in connection with FIGS. 2-9.

FIG. 2 shows a diagram 200 of a network 202 connecting to another network 206 via a serving gateway 204. By way of example, network 202 may correspond to a home cellular network service provider, whereas network 206 may correspond to a roaming cellular network service provider. Network 202 and network 206 may be connected through serving gateway 204 such that network 206 is enabled to provide cellular service to customers, subscribers, or other users of network 202 in accordance with a partnership agreement, for example.

By way of background, a serving gateway can refer to a device that is designed to protect a primary or home cellular network from unauthorized access or security threats when connecting to a roaming cellular network. The serving gateway can act as a secure bridge between the two networks, managing and filtering traffic to ensure that only authorized traffic passes through while blocking any unauthorized or potentially harmful traffic. The serving gateway can also provide encryption and authentication services to ensure the security and privacy of data transmitted between the two networks. In summary, the serving gateway can act as a line of defense against cyberattacks and other security threats that could compromise the integrity and availability of the cellular network.

A home cellular network and a roaming cellular network can form a partnership agreement for the provisioning of roaming services by negotiating terms that enable their subscribers to use each other's networks while traveling or visiting areas outside their home cellular network coverage. The agreement can include provisions for the exchange of network resources, such as voice and data services, between the two networks. This allows subscribers of the home cellular network to access the roaming cellular network and vice versa, for example, allowing them to make and receive calls, send messages, and access the Internet. The home cellular network operator can receive compensation for the use of its network by the visiting subscribers, which can be based on a negotiated fee structure. The partnership agreement for the provisioning of roaming services is one aspect of the mobile industry, as it enables subscribers to stay connected while traveling and expands the reach of mobile cellular network operators beyond their home cellular network coverage areas.

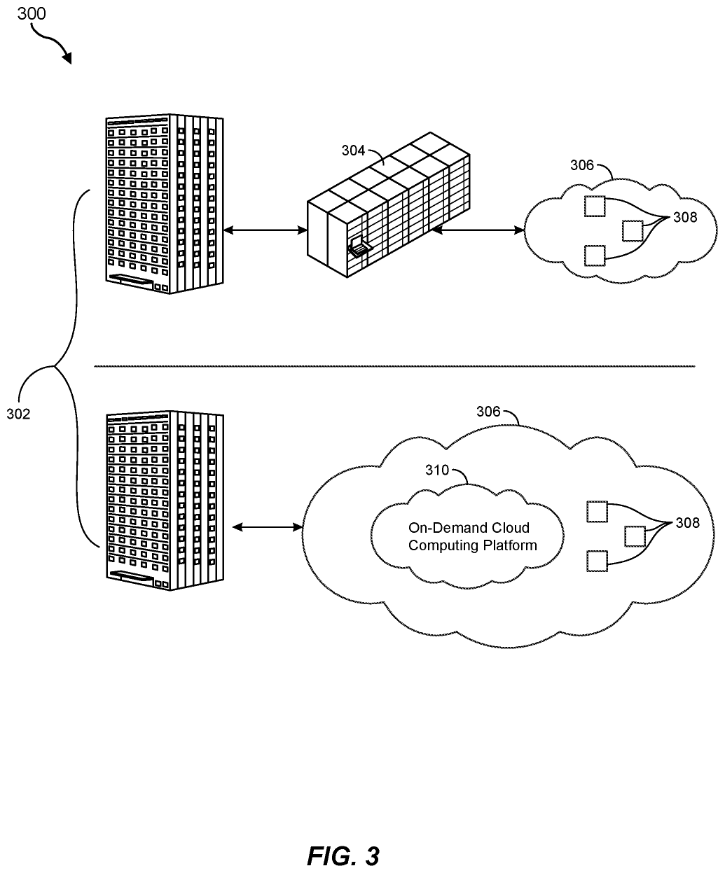

FIG. 3 shows a diagram 300, which further shows two different instances of a cellular network service provider 302. As further shown in this figure, diagram 300 may include both a top portion and a bottom portion. In the top portion of diagram 300, an instance of cellular network service provider 302 may build, install, configure, and maintain a massive amount of hardware infrastructure, such as a data server or server farm 304, in order to facilitate the provisioning of cellular network services. Such services may include the pinging or discovery of healthy serving gateways for the provisioning of roaming cellular services, as further outlined above in connection with FIG. 2. Accordingly, cellular network service provider 302 may establish server farm 304 in order to perform these pinging operations with respect to a wide area network 306, such as the Internet, which may include instances of nodes 308, such as serving gateways. In contrast, the bottom portion of diagram 300 shows another instance of cellular network service provider 302, yet this instance of cellular network service provider 302 directly communicates to wide area network 306 without the obstacle of establishing server farm 304. Rather than building and establishing server farm 304, the instance of cellular network service provider 302 on the bottom portion of diagram 300 communicates with an on-demand cloud computing platform 310, which itself is disposed within an instance of wide area network 306. By leveraging the elastic nature and massive computational power of on-demand cloud computing platform 310, the bottom instance of cellular network service provider 302 is enabled to more quickly, efficiently, and conveniently provide cellular service to its customers, subscribers, or users, in comparison to the usage of an in-house server farm 304, as further shown in this figure. In particular, usage of on-demand cloud computing platform 310 may facilitate the focus of the bottom instance of cellular network service provider 302 on creating appropriate software components and corresponding functionality, without the hassle and inconvenience associated with building, creating, establishing, and/or maintaining hardware infrastructure.

FIG. 3 also further illustrates how method 100 may operate through the on-demand cloud computing platform. In these more specific embodiments, method 100 may further include obtaining access to on-demand cloud computing platform 310 and registering at least one virtual machine in the on-demand cloud computing platform. Moreover, in such examples, pinging through the on-demand cloud computing platform can include installing a program for pinging each usable Internet Protocol address indicated by each respective identifier in the list of identifiers and executing the program through the at least one virtual machine.

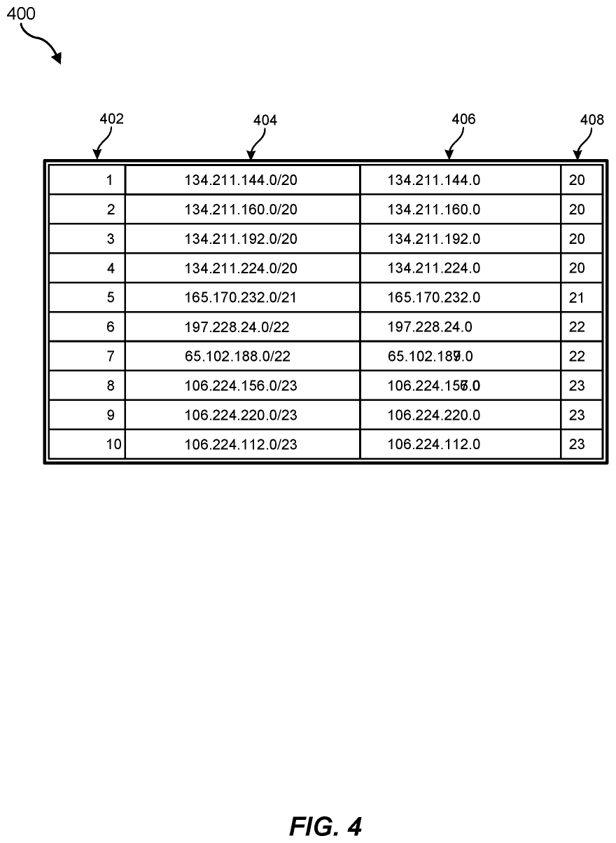

FIG. 4 helps to illustrate how, in this example, the list of identifiers includes a list of subnet definitions. FIG. 4 shows a diagram 400 that includes columns 402-408. Column 402 specifies the numbering of each respective row. Column 404 specifies a respective subnet definition within a list of subnet definitions. As outlined above, the list of subnet definitions may have been provided by a roaming cellular network service provider to a home cellular network service provider that has formed an agreement for the provisioning of roaming services. Column 406-408 split the subnet definition into a first portion (column 406) and a second portion (column 408), where the first portion indicates a set of bits assigned to a host and the second portion indicates a second set of bits assigned to a network definition. In particular, column 408 indicates a number of bits that have been assigned to the network definition, such that a remainder of a 32-bit Internet Protocol address has been assigned to the host indicated at column 406. In this particular example, 32 bits-20 bits would be 12 bits, which further indicates or defines a span of 4,096 Internet Protocol addresses.

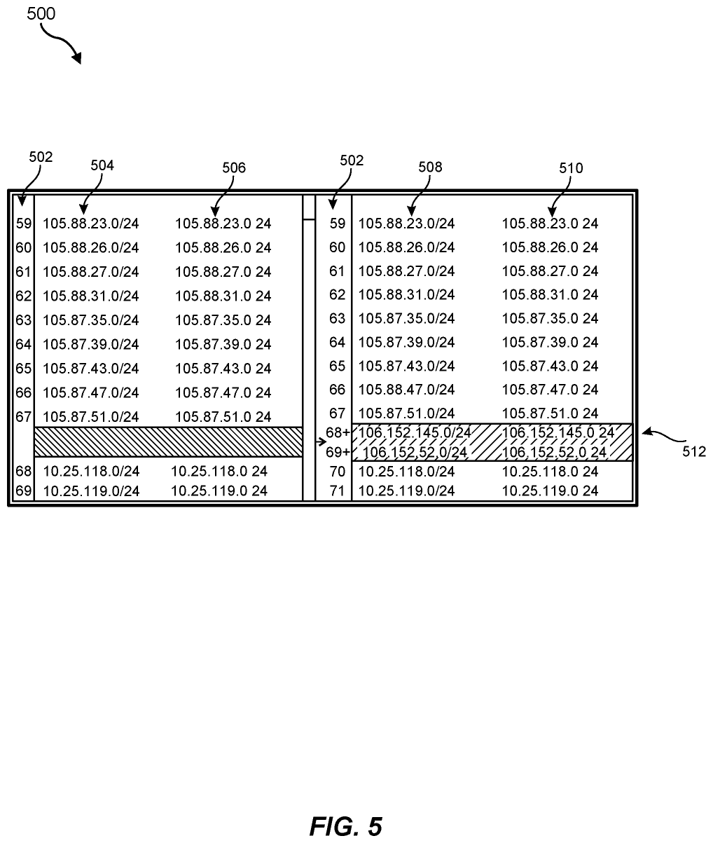

FIG. 5 helps to illustrate how, in some examples, method 100 may further include performing a differential operation between the list of identifiers and a second list of identifiers obtained at a subsequent point in time to ascertain which Internet Protocol addresses have been inserted into the second list of identifiers. In particular, this figure shows a diagram 500 that further includes columns 502-510. In several ways, diagram 500 parallels diagram 400. For example, column 504 and column 508 include subnet definitions. Column 506 and column 510 simply indicate a starting position of each subnet definition. Moreover, this figure illustrates how the left-hand side of diagram 500 and the right-hand side of diagram 500 substantially repeat each other. The repetition is the result of the fact that the left-hand side of diagram 500 indicates a list of subnet definitions that have been provided by a roaming cellular network service provider at one point in time (e.g., one month ago), whereas the right-hand side of diagram 500 indicates an updated version of the same list of subnet definitions that have been provided by the roaming cellular network service provider at a subsequent period of time, and in which additional subnet definitions have been inserted into the corresponding list. In particular, two additional subnet definitions have been inserted at the right-hand side of diagram 500 at row 68 and row 69, as further indicated by indicator 512.

FIG. 5 also illustrates how, in some examples, method 100 may further include sorting the list of identifiers by the remaining second set of bits assigned to the network definition. As further shown in this figure, all of the subnet definitions that are displayed have the same number of bits within the second portion that are assigned to the network definition (i.e., 24 bits), such that these different subnet definitions are grouped together. Although not expressly shown in this figure, additional subnet definitions may be grouped with other subnet definitions that have a smaller or larger number of bits in the second portion assigned to the network definition. In particular, by sorting the list of identifiers, the administrator or system controller, etc., has the option of focusing initial efforts on subnet definitions that indicate the largest continuous range of usable Internet Protocol addresses, for example, and as discussed in more detail below.

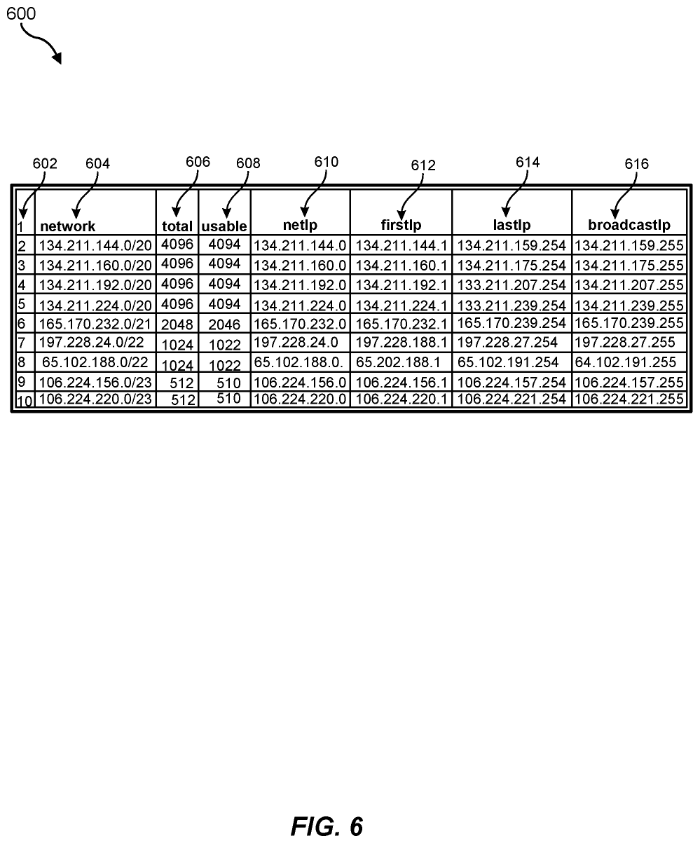

FIG. 6 shows another diagram 600 that elaborates on, and expands on, diagram 400, as further discussed above. Diagram 600 may include columns 602-616. As discussed above in connection with FIG. 4, the example of row two in diagram 600 may specify 20 bits within the second portion assigned to the network definition. Subtracting 20 bits from the 32 bits allocated to the subnet definition and corresponding Internet Protocol address returns a value of 12, which further indicates 4,096 total corresponding Internet Protocol addresses, as shown in column 606. Nevertheless, among these Internet Protocol addresses, not all of the Internet Protocol addresses are usable, because the first corresponding Internet Protocol address may be reserved as a network Internet Protocol address (column 610) and the last Internet Protocol address (column 616) may be reserved as a broadcast Internet Protocol address. Accordingly, from the 4,096 indicated Internet Protocol addresses, only 4,094 of these Internet Protocol addresses are actually usable. In other words, in some examples, a size of the continuous range spanning from column 612 (the first Internet Protocol address in the usable range) and column 614 (the last INTERNET Protocol address in the usable range) is a value defined as: (2\hat{ }(32−the number of bits in the remaining set of bits assigned to the network definition))−2).

The range of continuous usable Internet Protocol addresses (e.g., the range from column 612 to column 614 in FIG. 6) has been indicated to the home cellular network service provider, by the roaming cellular network service provider, by sharing the corresponding subnet definition, to notify the home cellular network service provider that one or more packet data nodes, such as serving gateways as discussed above, may be located within that particular range. In other words, the roaming cellular network service provider does not, and perhaps cannot, share the exact Internet Protocol addresses for these packet data nodes, or keep the list static over time, because the corresponding roaming cellular network is regularly growing, expanding, and evolving. Nevertheless, the roaming cellular network service provider can indicate to the home cellular network service provider the corresponding subnet definition, thereby helping to constrain the search space in which the home cellular network service provider can identify actual instances of healthy or responding serving gateways. Upon successfully identifying one or more serving gateways, the home cellular network service provider can appropriately connect and use the serving gateways for the provisioning of roaming cellular service, as discussed above.

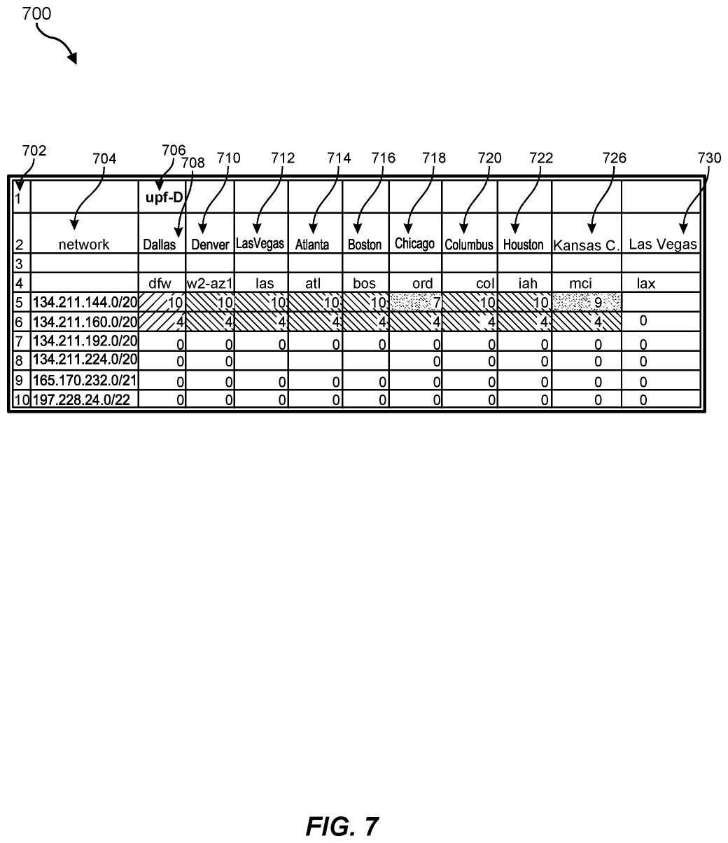

FIG. 7 shows another diagram 700 that helps to further illustrate the performance of method 100 and corresponding results of performing this method. As further shown in this figure, diagram 700 may include column 702-730. Diagram 700 helps illustrate the performance of method 100 by showing how a number of responsive packet data nodes, such as serving gateways, can be detected or identified from a corresponding server device of the home cellular network service provider at each cell for the intersection between a geographic hub and a corresponding subnet definition. By way of illustrative example, the intersection of row five and column 706 for Dallas-Fort Worth includes a cell having the value 10, thereby indicating that the particular server device in Dallas-Fort Worth (“upf-d,” or a User Plane Function node labeled “d”) successfully found and located 10 different serving gateways within the continuous range of usable Internet Protocol addresses indicated by the corresponding subnet definition. Similarly, the intersection of row six and column 712 for Las Vegas includes the cell having the value four, thereby indicating that the particular server device operated by the home cellular network service provider in Las Vegas successfully found and located four different serving gateways within the continuous range of usable Internet Protocol addresses indicated by the corresponding subnet definition. The rest of the cells within diagram 700 proceed in a manner that is essentially parallel.

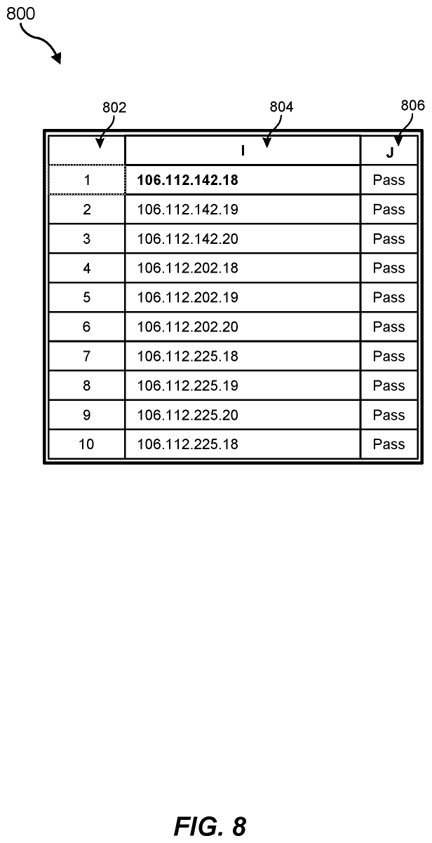

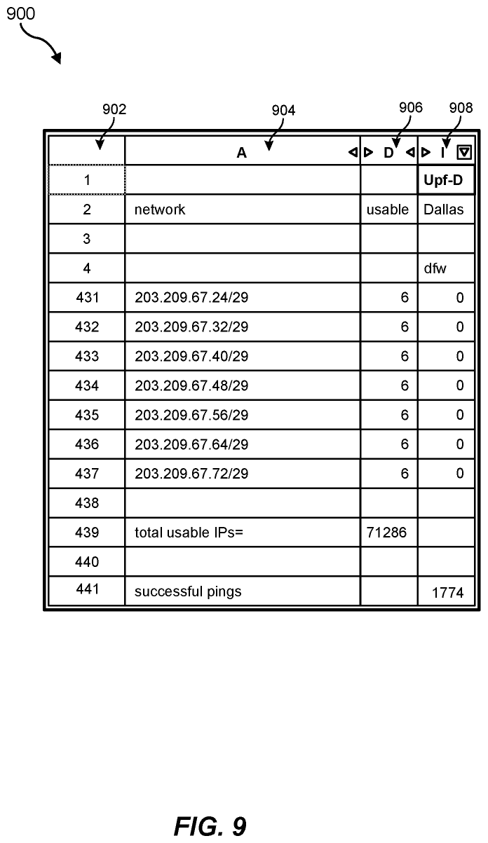

For completeness, this application also discloses FIGS. 8-9, which drill down into further specific details regarding the detected and located Internet Protocol addresses for healthy and responsive packet data nodes of the roaming cellular network service provider. In particular, FIG. 8 shows a diagram 800 that includes columns 802-806. Column 802 simply indicates the index number for a respective row. Column 804 identifies the specific and exact Internet Protocol address for a healthy and responsive serving gateway detected and identified through the performance of method 100, as discussed further above. Lastly, column 806 indicates “Pass” for each respective row within diagram 800, thereby providing confirmation that the particular Internet Protocol address at that respective row passed the corresponding pinging test by indicating health and responsiveness to the home cellular network service provider.

Similarly, FIG. 9 shows the vertical bottom of the same overall table shown within diagram 700. Diagram 900 includes columns 902-908. In particular, column 908 corresponds to the server device of the home cellular network service provider in the Dallas-Fort Worth geographic hub area. Rather than starting with subnet definitions indicating the largest numbers of usable Internet Protocol addresses, as in diagram 700, the portion depicted in diagram 900 is focused on the vertical bottom of this table, which has the lowest number of usable Internet Protocol addresses (e.g., six as indicated by column 906 in diagram 900). Furthermore, row 441 of diagram 900 reports the total number of successful pings that were performed by the server device corresponding to the Dallas-Fort Worth geographic hub. Accordingly, the Internet Protocol addresses for the successful pings shown in diagram 800 are just a small excerpt from the 1,774 successful pings performed by the corresponding Dallas-Fort Worth server device with respect to each of the subnet definitions indicated by respective rows, ending with row 437 shown in diagram 900.

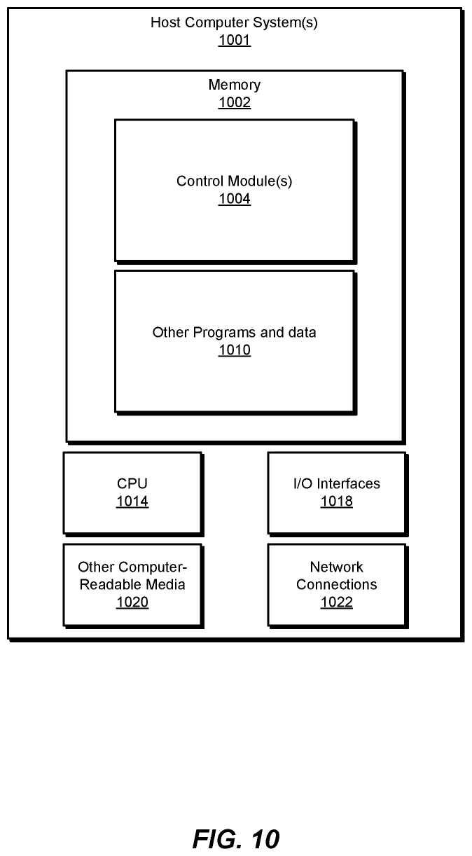

FIG. 10 shows a system diagram that describes an example implementation of a computing system(s) for implementing embodiments described herein. The functionality described herein for radio access network slicing can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 10 illustrates an example of underlying hardware on which such software and functionality may be hosted and/or implemented.

In particular, shown is example host computer system(s) 1001. For example, such host computer system(s) 1001 may execute a scripting application, or other software application, to perform method 100, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1001 may include memory 1002, one or more central processing units (CPUs) 1014, I/O interfaces 1018, other computer-readable media 1020, and network connections 1022.

Memory 1002 may include one or more various types of non-volatile and/or volatile storage technologies. Examples of memory 1002 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1002 may be utilized to store information, including computer-readable instructions that are utilized by CPU 1014 to perform actions, including those of embodiments described herein.

Memory 1002 may have stored thereon control module(s) 1004. The control module(s) 1004 may be configured to implement and/or perform some or all of the functions of the systems or components described herein for radio access network slicing. Memory 1002 may also store other programs and data 1010, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1022 are configured to communicate with other computing devices to facilitate the functionality described herein. In various embodiments, the network connections 1022 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1018 may include a video interface, other data input or output interfaces, or the like. Other computer-readable media 1020 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
obtaining, by a home cellular network service provider from a roaming cellular network service provider, a list of identifiers indicating respective ranges of Internet Protocol addresses that are targets for remote packet data nodes of the roaming cellular network service provider;
for each respective server, in a list of respective servers that the home cellular network service provider assigned to respective geographic hubs, pinging through an on-demand cloud computing platform each usable Internet Protocol address indicated by each respective identifier in the list of identifiers; and
discovering, by the home cellular network service provider, in response to the pinging, which Internet Protocol addresses indicated a healthy remote packet data node of the roaming cellular network service provider.

2. The method of claim 1, wherein the list of identifiers comprises a list of subnet definitions.

3. The method of claim 2, wherein each respective identifier in the list of identifiers indicates a first set of bits assigned to a host and a remaining second set of bits assigned to a network definition.

4. The method of claim 3, wherein a set of usable Internet Protocol addresses indicated by each respective identifier in the list of identifiers comprises a continuous range of Internet Protocol addresses.

5. The method of claim 4, wherein the continuous range of Internet Protocol addresses excludes a starting network Internet Protocol address and an ending broadcast Internet Protocol address as defined by each respective identifier in the list of identifiers.

6. The method of claim 4, wherein a size of the continuous range is (2\hat{ }(32−the number of bits in the remaining set of bits assigned to the network definition))−2.

7. The method of claim 3, further comprising sorting the list of identifiers by the remaining second set of bits assigned to the network definition.

8. The method of claim 1, wherein pinging through the on-demand cloud computing platform comprises:
obtaining access to the on-demand cloud computing platform; and
registering at least one virtual machine in the on-demand cloud computing platform.

9. The method of claim 8, wherein pinging through the on-demand cloud computing platform comprises:
installing a program for pinging each usable Internet Protocol address indicated by each respective identifier in the list of identifiers; and
executing the program through the at least one virtual machine.

10. The method of claim 1, further comprising performing a differential operation between the list of identifiers and a second list of identifiers obtained at a subsequent point in time to ascertain which Internet Protocol addresses have been inserted into the second list of identifiers.

11. A system comprising:
at least one physical processor; and
a non-transitory computer-readable medium encoding instructions that, when executed by the at least one physical processor, cause operations to be performed comprising:
obtaining, by a home cellular network service provider from a roaming cellular network service provider, a list of identifiers indicating respective ranges of Internet Protocol addresses that are targets for remote packet data nodes of the roaming cellular network service provider;
for each respective server, in a list of respective servers that the home cellular network service provider assigned to respective geographic hubs, pinging through an on-demand cloud computing platform each usable Internet Protocol address indicated by each respective identifier in the list of identifiers; and
discovering, by the home cellular network service provider, in response to the pinging, which Internet Protocol addresses indicated a healthy remote packet data node of the roaming cellular network service provider.

12. The system of claim 11, wherein the list of identifiers comprises a list of subnet definitions.

13. The system of claim 12, wherein each respective identifier in the list of identifiers indicates a first set of bits assigned to a host and a remaining second set of bits assigned to a network definition.

14. The system of claim 13, wherein a set of usable Internet Protocol addresses indicated by each respective identifier in the list of identifiers comprises a continuous range of Internet Protocol addresses.

15. The system of claim 14, wherein the continuous range of Internet Protocol addresses excludes a starting network Internet Protocol address and an ending broadcast Internet Protocol address as defined by each respective identifier in the list of identifiers.

16. The system of claim 14, wherein a size of the continuous range is (2\hat{ }(32−the number of bits in the remaining set of bits assigned to the network definition))−2.

17. The system of claim 13, further comprising sorting the list of identifiers by the remaining second set of bits assigned to the network definition.

18. The system of claim 11, wherein pinging through the on-demand cloud computing platform comprises:
obtaining access to the on-demand cloud computing platform; and
registering at least one virtual machine in the on-demand cloud computing platform.

19. The system of claim 18, wherein pinging through the on-demand cloud computing platform comprises:
installing a program for pinging each usable Internet Protocol address indicated by each respective identifier in the list of identifiers; and
executing the program through the at least one virtual machine.

20. A non-transitory computer-readable medium encoding instructions that, when executed by at least one physical processor of a computing device, cause the computing device to perform a method comprising:
obtaining, by a home cellular network service provider from a roaming cellular network service provider, a list of identifiers indicating respective ranges of Internet Protocol addresses that are targets for remote packet data nodes of the roaming cellular network service provider;
for each respective server, in a list of respective servers that the home cellular network service provider assigned to respective geographic hubs, pinging through an on-demand cloud computing platform each usable Internet Protocol address indicated by each respective identifier in the list of identifiers; and
discovering, by the home cellular network service provider, in response to the pinging, which Internet Protocol addresses indicated a healthy remote packet data node of the roaming cellular network service provider.
